(19) United States
(12) Patent Application Publication
(10) Pub. No.: US 2021/0356563 A1
(43) Pub. Date: Nov. 18, 2021

(54) LIGHT DETECTION AND RANGING SYSTEM WITH POLYGON SHAPED ENCLOSURE

(71) Applicant: BEIJING VOYAGER TECHNOLOGY CO., LTD., Beijing (CN)

(72) Inventors: Anan Pan, Mountain View, CA (US); Henghui Jiang, Los Gatos, CA (US)

(73) Assignee: BEIJING VOYAGER TECHNOLOGY CO., LTD., Beijing (CN)

(21) Appl. No.: 15/931,555

(22) Filed: May 13, 2020

(51) Int. Cl. G01S 7/481; G01S 17/931

(52) U.S. Cl. CPC G01S 7/4813; G01S 17/931; G01S 7/4817

(57) ABSTRACT

Embodiments of the disclosure provide a Light Detection and Ranging (LiDAR) system. The LiDAR system includes a transmitter configured to emit a light beam and a receiver configured to receive the light beam reflected by an object. The LiDAR system also includes an enclosure enclosing the transmitter and the receiver. The enclosure includes a plurality of laterals. Each of the laterals includes a cover overmold with a first waterproofed material and a first cap head screw configured to fix the cover to a cover on a connecting lateral.

### TECHNICAL FIELD

The present disclosure relates to optical sensing systems such as a light detection and ranging (LiDAR) system, and more particularly to, a LiDAR system with polygon shaped waterproof enclosure.

### BACKGROUND

Optical sensing systems such as LiDAR systems have been widely used in autonomous driving and producing high-definition maps. For example, a typical LiDAR system measures the distance to a target by illuminating the target with pulsed laser light beams and measuring the reflected pulses with a sensor such as a photodetector or a photodetector array. Differences in laser light return times, wavelengths, and/or phases can then be used to construct digital three-dimensional (3D) representations of the target. Because using a narrow laser beam as the incident light can map physical features with very high resolution, a LiDAR system is particularly suitable for applications such as sensing in autonomous driving and high-definition map surveys.

LiDAR systems includes multiple electronic components such as transmitters for emitting the laser light beams and receivers (e.g., photodetectors) for receiving the reflected/returned pulses. Because the electronic components are delicate and are sensitive to interference, an enclosure to protect them from external environment such as dust and water is needed.

Conventional enclosures are in cylinder or polygon shapes such that the pulsed laser light beams emitted by the LiDAR system can be directed to multiple directions to cover a field of view (FOV). However, cylinder shaped enclosures lack the scalability as the side area of the cylinder body are normally formed in one piece. On the other hand, conventional polygon shaped enclosures have multiple connected laterals. However, to ensure water resistance, conventional polygon shaped enclosures use glue or welding to fix/hold together the connecting parts. Thus, the enclosures not only have limited scalability because of the enclosure (e.g., hard to dissemble and add laterals), but also are not environmentally friendly for manufacturing because of the materials used for fixing and sealing.

Embodiments of the present disclosure address the above problems.

### SUMMARY

Embodiments of the disclosure provide a Light Detection and Ranging (LiDAR) system. The LiDAR system includes a transmitter configured to emit a light beam and a receiver configured to receive the light beam reflected by an object. The LiDAR system also includes an enclosure enclosing the transmitter and the receiver. The enclosure includes a plurality of laterals. Each of the laterals includes a cover overmold with a first waterproof material and a first cap head screw configured to fix the cover to a cover on a connecting lateral.

Embodiments of the disclosure also LiDAR system made by performing a LiDAR manufacturing method. The LiDAR manufacturing method includes fixing a plurality of covers overmold with a first waterproof material to form laterals of an enclosure using a plurality of first cap head screws. Each cover is fixed to two connecting covers of the laterals. The LiDAR manufacturing method also includes disposing in the enclosure a transmitter configured to emit a light beam and a receiver configured to receive the light beam reflected by an object.

Embodiments of the disclosure further provide LiDAR system. The LiDAR system includes a transmitter configured to emit a light beam and a receiver configured to receive the light beam reflected by an object. The LiDAR system also includes a plurality of covers forming laterals of a waterproof enclosure. Each of the laterals includes a cover overmold with a first waterproofed material and a window holder disposed on the cover, configured to hold a window for letting out and letting in the light beam. Connecting covers among the plurality of covers are fixed using a plurality of first waterproof screws.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary vehicle equipped with a LiDAR system, according to embodiments of the disclosure.

FIG. 2 illustrates a block diagram of an exemplary LiDAR system, according to embodiments of the disclosure.

FIG. 3 illustrates an exemplary top front perspective view of an enclosure, according to embodiments of the disclosure.

FIG. 4 illustrates an exemplary isometric diagram of a waterproof screw, according to embodiments of the disclosure.

FIG. 5 illustrates an exemplary rear view of a cover, according to embodiments of the disclosure.

FIG. 6 illustrates an exemplary isometric diagram of a window holder, according to embodiments of the disclosure.

FIG. 7 illustrates a flow chart of exemplary method for manufacturing a LiDAR system, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Embodiments of the present disclosure provide LiDAR systems/devices with waterproof polygon shaped enclosures fixed without glue or welding, and methods for manufacturing the same. For example, core components (e.g., transmitter(s) and receiver(s)) of the LiDAR system can be enclosed by a polygon shaped enclosure with multiple (e.g., 4, 6, 8, 10, 12 or more) laterals. Each of the laterals includes a cover, overmold with a waterproof material covering each edge of the cover that is in contact with a connecting cover. The covers, when connected together, form the laterals of the polygon shaped enclosure. The waterproof material can stop water from entering the enclosure through the gap between the connecting covers, and thus, ensure water resistance of the LiDAR system.

In some embodiments, the connecting covers can be fixed to each other using a plurality of waterproof screws/bolts. For example, the connecting covers can be fixed together by sharing an angle bracket (e.g., a L type bracket, a L type fixed piece, etc.). The two hands of the angle bracket can be at an angle equal to the internal angle of the polygon shape. Each cover is then attached to one hand of the angle bracket using the plurality of waterproof screws. To ensure water resistance, each of the waterproof screws can have a cap head, plated with a waterproof material on the lateral surface of the cap head. The waterproof material plating the cap head of the waterproof screw can seal the gap between the pin hole on the angle bracket and the cap head of the plurality of waterproof screws, and stop water from entering the enclosure through the same.

In some embodiments, each cover also has a window holder disposed on an inner side of the cover (e.g., the inside of the enclosure where the core components such as the transmitter and the receiver are disposed), an outer side of the cover (e.g., the outside of the enclosure, opposite to the inside) or both. The window holder may be configured to hold a window for letting in and letting out the light beam generated by the transmitter. For example, the window can be held at substantially the same height/level as the transmitter and the receiver, such that the emitted light beam and the return light beam (e.g., reflected by an object) can pass through the window. The window can be fixed to the cover using at least one waterproof screw, similar to (e.g., having the similar structure and using a similar kind of waterproof material) or being the same as, the plurality of screws used for fixing/holding together the connecting covers. The waterproof screw used for fixing the window holder to the cover can stop external materials (e.g., dust and water) from entering the internal space of the LiDAR system through the gap between the window holder and the cover.

In some embodiments, the waterproof enclosure can further include a plate (e.g., a substrate where each of the core components are disposed on) and a cap (e.g., providing a roof covering the laterals of the polygon shape enclosure). The plate and the cap can be fixed to the laterals by fixing to each of the covers using angle brackets and waterproof screws, similar to the mechanism the connecting covers are fixed to each other. The edge connecting each cover with the plate and the cap can also be covered/overmold with the waterproof material to provide water resistance.

By using the waterproof screws for fixing each parts of the enclosure without using any glue or welding, each part of the enclosure (e.g., the covers, the plate and the cap) can be detached and replaced more conveniently. Accordingly, embodiments of the present disclosure improve the scalability of the LiDAR system. Moreover, by not using glue or welding, the manufacture of the enclosure can be more environmentally friendly.

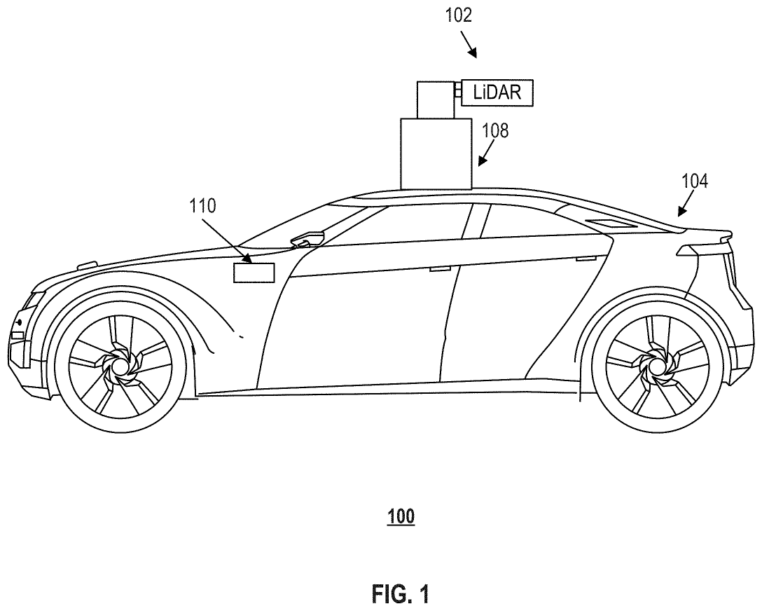

FIG. 1 illustrates a schematic diagram of an exemplary vehicle 100 equipped with a LiDAR system 102, according to embodiments of the disclosure. Consistent with some embodiments, vehicle 100 may be a survey vehicle configured for acquiring data for constructing a high-definition map or 3-D buildings and city modeling. Vehicle 100 may also be an autonomous driving vehicle.

As illustrated in FIG. 1, vehicle 100 may be equipped with LiDAR system 102 mounted to a body 104 via a mounting structure 108. Mounting structure 108 may be an electro-mechanical device installed or otherwise attached to body 104 of vehicle 100. In some embodiments of the present disclosure, mounting structure 108 may use screws, adhesives, or another mounting mechanism. Vehicle 100 may be additionally equipped with a sensor 110 inside or outside body 104 using any suitable mounting mechanisms. Sensor 110 may include sensors used in a navigation unit, such as a Global Positioning System (GPS) receiver and one or more Inertial Measurement Unit (IMU) sensors. It is contemplated that the manners in which LiDAR system 102 or sensor 110 can be equipped on vehicle 100 are not limited by the example shown in FIG. 1 and may be modified depending on the types of LiDAR system 102 and sensor 110 and/or vehicle 100 to achieve desirable 3D sensing performance.

Consistent with some embodiments, LiDAR system 102 and sensor 110 may be configured to capture data as vehicle 100 moves along a trajectory. For example, a transmitter of LiDAR system 102 may be configured to scan the surrounding environment. LiDAR system 102 measures distance to a target by illuminating the target with pulsed laser beam and measuring the reflected pulses with a receiver. The laser beam used for LiDAR system 102 may be ultraviolet, visible, or near infrared. In some embodiments of the present disclosure, LiDAR system 102 may capture point clouds including depth information of the objects in the surrounding environment. As vehicle 100 moves along the trajectory, LiDAR system 102 may continuously capture data. Each set of scene data captured at a certain time range is known as a data frame.

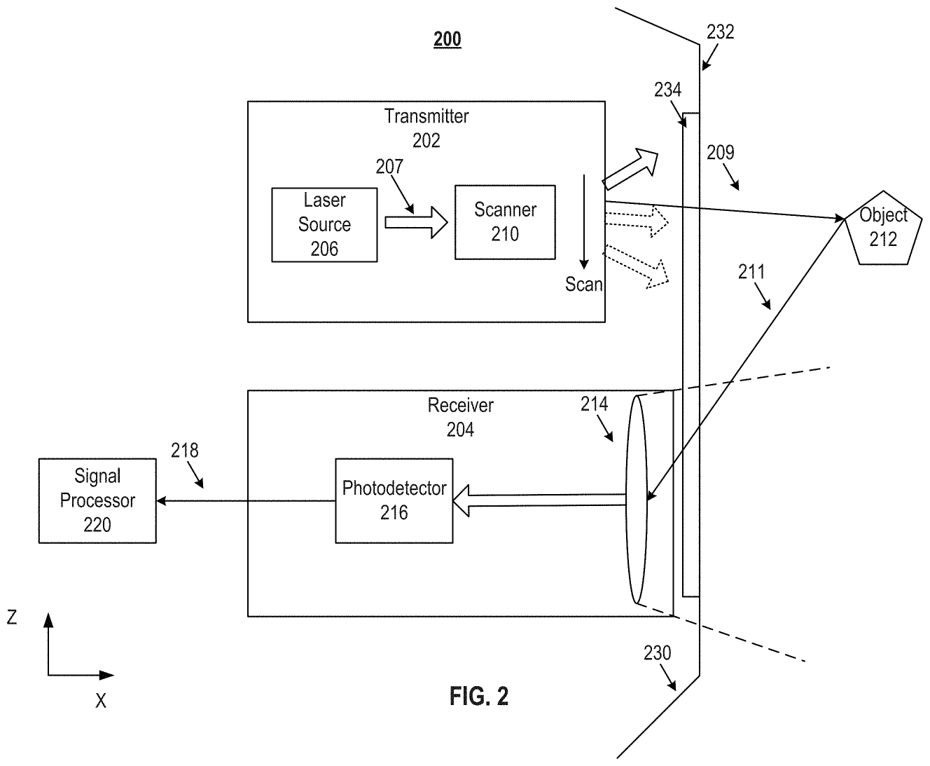

FIG. 2 illustrates a block diagram of an exemplary LiDAR system 102, according to embodiments of the disclosure. LiDAR system 102 may include a transmitter 202 and a receiver 204. Transmitter 202 may emit laser beams along multiple directions. Transmitter 202 may include one or more laser sources 206 and a scanner 210.

Transmitter 202 can sequentially emit a stream of pulsed laser beams in different directions within a scan range (e.g., a range in angular degrees), as illustrated in FIG. 2. Laser source 206 may be configured to provide a laser beam 207 (also referred to as “native laser beam”) to scanner 210. In some embodiments of the present disclosure, laser source 206 may generate a pulsed laser beam in the ultraviolet, visible, or near infrared wavelength range.

In some embodiments of the present disclosure, laser source 206 may include a pulsed laser diode (PLD), a vertical-cavity surface-emitting laser (VCSEL), a fiber laser, etc. For example, a PLD may be a semiconductor device similar to a light-emitting diode (LED) in which the laser beam is created at the diode's junction. Depending on the semiconductor materials, the wavelength of incident laser beam 207 provided by a PLD may be smaller than 1,100 nm, such as 405 nm, between 445 nm and 465 nm, between 510 nm and 525 nm, 532 nm, 635 nm, between 650 nm and 660 nm, 670 nm, 760 nm, 785 nm, 808 nm, or 848 nm. It is understood that any suitable laser source may be used as laser source 206 for emitting laser beam 207.

Scanner 210 may be configured to emit a laser beam 209 to an object 212 in a first direction. Object 212 may be made of a wide range of materials including, for example, non-metallic objects, rocks, rain, chemical compounds, aerosols, clouds and even single molecules. The wavelength of laser beam 209 may vary based on the composition of object 212. In some embodiments, at each time point during the scan, scanner 210 may emit laser beam 209 to object 212 in a direction within a range of scanning angles by rotating the micromachined mirror assembly. In some embodiments of the present disclosure, scanner 210 may also include optical components (e.g., lenses, mirrors) that can focus pulsed laser light into a narrow laser beam to increase the scan resolution and the range to scan object 212.

Upon contact, laser light can be reflected by object 212 via backscattering, such as Rayleigh scattering, Mie scattering, Raman scattering, and fluorescence. In some embodiments, receiver 204 may be configured to detect a returned laser beam 211 returned from object 212. The returned laser beam 211 may be in a different direction from beam 209. Receiver 204 can collect laser beams returned from/reflect by object 212 and output electrical signals reflecting the intensity of the returned laser beams. As illustrated in FIG. 2, receiver 204 may include a lens 214 and a photodetector 216. Lens 214 may be configured to collect light from a respective direction in its field of view (FOV). Photodetector 216 may be configured to detect returned laser beam 211 returned from object 212. In some embodiments, photodetector 216 may convert the laser light (e.g., returned laser beam 211) collected by lens 214 into an electrical signal 218 (e.g., a current or a voltage signal).

In some embodiments, LiDAR device 200 may include a signal processor 220 configured to process electrical signal 218. For example, signal processor 220 may include an analog to digital converter to convert electrical signal 218 that may be an analog signal to a digital signal. In another example, signal processor 220 may include one or more filters, noise reducers, signal enhancer, or the like to improve the signal-to-noise ratio (SNR) of electrical signal 218. Signal processor 220 may include a microprocessor, a digital signal processor (DSP), a microcontroller, a field programmable gate array (FPGA), and/or other suitable devices or chips capable of processing electrical signal 218.

In some embodiments, at least transmitter 202 and receiver 204 are disposed in a waterproof enclosure 230 (hereinafter referred to as “enclosure 230”), to be protected from external materials such as dust and water. In some embodiments, enclosure 230 may be any suitable case that can enclose core components of LiDAR device 200 disclosed above, and provide water resistance to LiDAR device 200. For example, enclosure 230 may be made of metal, plastic, alloy, nylon, glass, etc., or a mixture of materials. In some embodiments, enclosure 230 may include a plurality of covers 232, forming the laterals of enclosure 230. Each cover 232 may include a window holder 234 for holding and fixing a window (not shown) for letting out laser beam 209 and letting in returned laser beam 211. For example, the window held by/fastened to window holder 234 may be at substantially the same level (in the direction perpendicular to FIG. 2) as transmitter 202 and receiver 204, such that laser beam 209 and returned laser beam 211 can pass through the window to cover the range of scanning angles of laser beam 209 and be received by receiver 204. The size of the window may be designed sufficient to accommodate the FOVs of transmitter 202 and receiver 204.

In some embodiments, cover 232 may further include a plate (not shown) and a cap (not shown) covering the bottom and the top of the laterals. In some embodiments, the plate may be a printed circuit board (PCB) for providing both mechanical support and peripheral circuits for facilitating core components such as transmitter 202 and receiver 204. To make enclosure 230 water resistant, the top side of the cap and the bottom side of the substrate are also waterproof.

In some embodiments, when adjusting the emitting direction of laser beam 209 to scan the FOV, LiDAR device 200 may also include a motor (not shown) for generating a relative rotation between transmitter 202 and enclosure 230. For example, enclosure 230 may be fixed to the survey vehicle (e.g., vehicle 100) through a mounting structure (e.g., mounting structure 108), and transmitter 202 can rotate (e.g., driven by the motor) relative to enclosure 230 to adjust the emitting direction of laser beam 209. In some other embodiments, the FOV can also be scanned by fixing the incident angle of laser beam 207 relative to scanner 210, and the scanning of laser beam 209 may be achieved by rotating a mirror or an array of micro mirrors assembled in scanner 210 by Micro-electromechanical (MEMS) motors or other suitable mechanisms (e.g., electrostatic, magnetic or piezoelectric actuators).

It is contemplated that, spatially relative terms, such as “top”, “bottom”, “inside”, “outside” and the like are used herein to describe the spatial relationships of elements or features as illustrated in the figures. These terms are only used to describe the spatial position of such elements or features according to particular orientations of the device. For example, a “top” of a device in the orientation depicted in the figures may become the “bottom” when the device is rotated 180 degrees. Therefore, the spatially relative descriptors used herein shall be interpreted accordingly.

By using a waterproof enclosure (e.g., enclosure 230) to enclosure core components of LiDAR device 200, LiDAR device 200 can be protected against ingress of particles (e.g., dust) and ingress of liquids (e.g., water). Also, as each lateral of enclosure 230 is formed by cover 232 detachable from enclosure 230 (will be disclosed in greater detail below), the scalability of LiDAR device 200 is improved (e.g., adding or removing lateral(s) to enclosure 230).

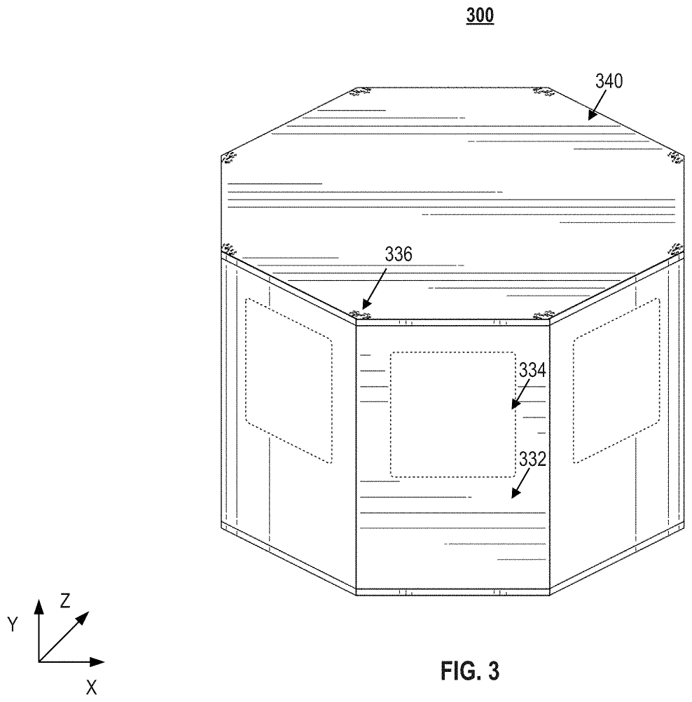

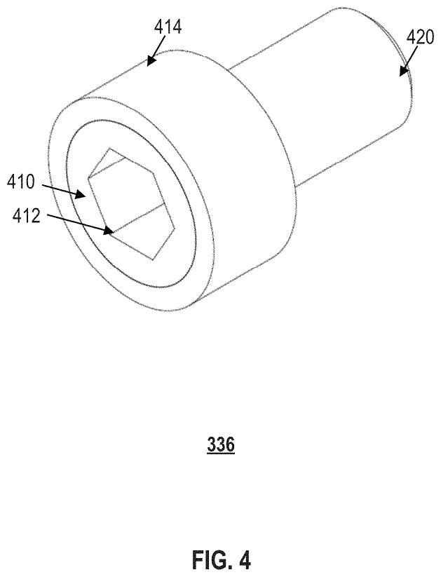

In some embodiments, enclosure 230 is in a polygon shape and may have 4, 6, 8, 10, 12 or any other suitable number (even or odd) of laterals. For one example, FIG. 3 illustrates an exemplary top front perspective view of enclosure 300 having 8 laterals, according to embodiments of the disclosure. As illustrate in FIG. 3, multiple covers 332 may form the laterals of enclosure 300. In some embodiments, enclosure 300 may also include a cap 340 for covering and a substrate (not shown) for providing a bottom for the laterals formed by covers 332. For example, cap 340 may be fixed to each cover 332 through one or more waterproof screws/bolts 336 (hereinafter referred as “waterproof screw 336”). For example, FIG. 4 illustrates an isometric view of an exemplary waterproof screw 336 as shown in FIG. 3, according to embodiments of the disclosure. In some embodiments, waterproof screw 336 may include a cap head 410 and a shank 420. Cap head 410 may include a hexagon column 412 for fastening/screwing waterproof screw 400. In some other embodiments, cap head 410 may also have a screw-driver slot or other suitable structures for fastening/screwing instead of having hexagon column 412.

In some embodiments, cap head 410 may be plated with a waterproof material 414 around a lateral of cap head 410. Waterproof material 414 may seal the gap between the lateral of cap head 410 and the pin holes in which cap head 410 is disposed (e.g., the pin holes on cap 340 and cover 332) and can provide protection to the gap (e.g., sealing the gap) against ingress of water and dust. In some embodiments, waterproof material 414 may be any suitable waterproof sealing compound such as rubber, glue, silicone, polyurethane, tripolymer, etc.

In some embodiments, shank 420 may include threads (not shown) for converting the rotational motion to the linear motion when fastening the connecting parts. In some other embodiments, shank 420 may be tight fitted or interference fitted into cap 340 and/or cover 332.

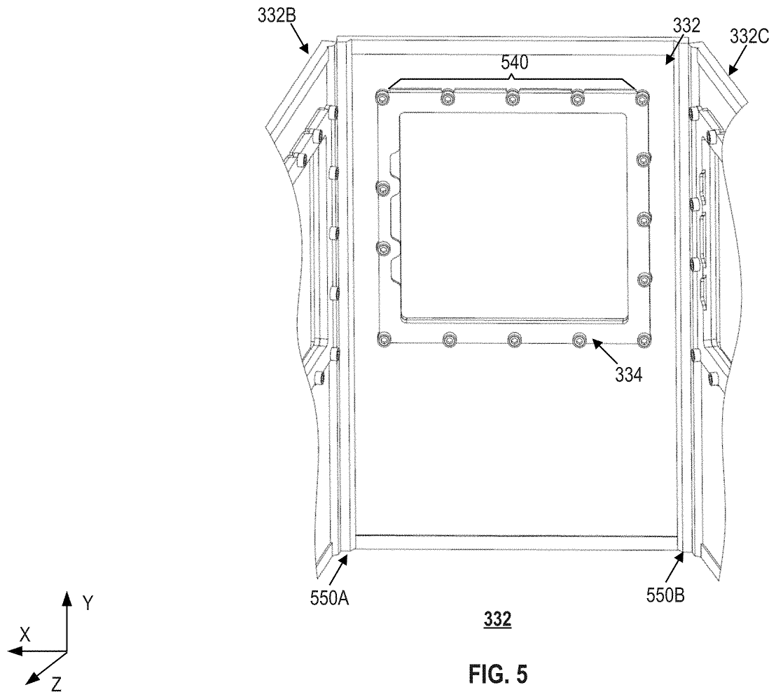

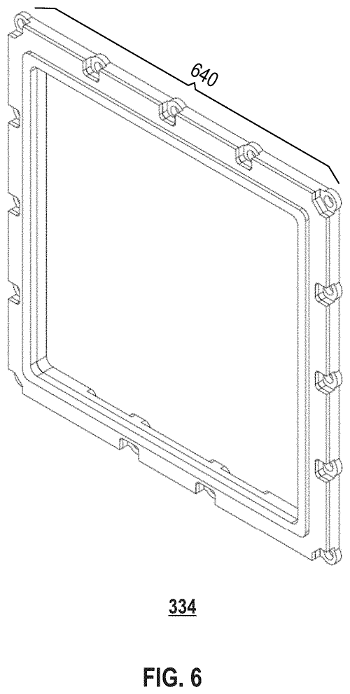

In some embodiments, cover 332 may also include a window holder 334 for holding a window to let out the emitted laser beam (e.g., laser beam 209) and let in the reflected laser beam (e.g., returned laser beam 211). For example, FIG. 5 illustrates an exemplary rear view of cover 332 and FIG. 6 illustrates an exemplary isometric diagram of window holder 334, as shown in FIG. 3, according to embodiments of the disclosure.

As illustrated in FIGS. 5 and 6, window holder 334 may be disposed on cover 332 at substantially the same height (e.g., at the same level along y axis) with transmitter 202 and receiver 204 such that the emitted laser beam (e.g., laser beam 209) can be let out to cover the range of scanning angles, and the reflected laser beams (e.g., returned laser beam 211) can be let in to be received by receiver 204 through the window (not shown) held by window holder 334. In some embodiments, the window can be made of any suitable transparent or translucent materials such as plastic, glass, crystal, etc.

In some embodiments, window holder 334 may be fixed to cover 332 by having a set of pin holes 540 corresponding to a set of pin holes 640 disposed on cover 332. For example, each pin hole 540 may align with a pin hole 640 such that at least a portion of a shank of a waterproof screw (e.g., a screw similar to waterproof screw 336 as illustrated in FIG. 4) can be received by pin hole 540 and 640 for fixing the two parts.

It is contemplated that the waterproof screws used for holding cover 332 and window holder 334 may be the same as waterproof screw 336, may be waterproof screws with similar design but different diameters, or may be any other suitable waterproof screws that can seal the gap. It is also contemplated that the shape of window holder 334 is not limited to square. The shape of window holder 334 can also be triangle, rectangle, other polygon with four edges, six edges, eight edges, or any other suitable shape corresponding to the shape of the window to be held.

It is also contemplated that the number of pin holes 640 on each edge of window holder 334 shown in the present example is for illustrative purpose only. Each edge of window holder 334 may have even number of or different number of pin holes 640 for fixing the window to cover 332.

As illustrated in FIG. 5, cover 332 may also be connected to connecting covers 332B and 332C by sharing edges. In some embodiments, cover 332 may be connected to connecting cover 332B using angle bracket(s) with waterproof screws, or any other suitable waterproof screw-based connecting mechanism. In some embodiments, cover 332 is overmold with a waterproof material such that connecting edges 550A and 550B is water resistant. For example, each connecting edge 550A or 550B of cover 332 may include the waterproof material such that the gaps between the connecting covers are sealed. Connecting edges 550A and 550B may be sealed by any suitable waterproof sealing compound such as rubber, glue, silicone, polyurethane, tripolymer, etc.

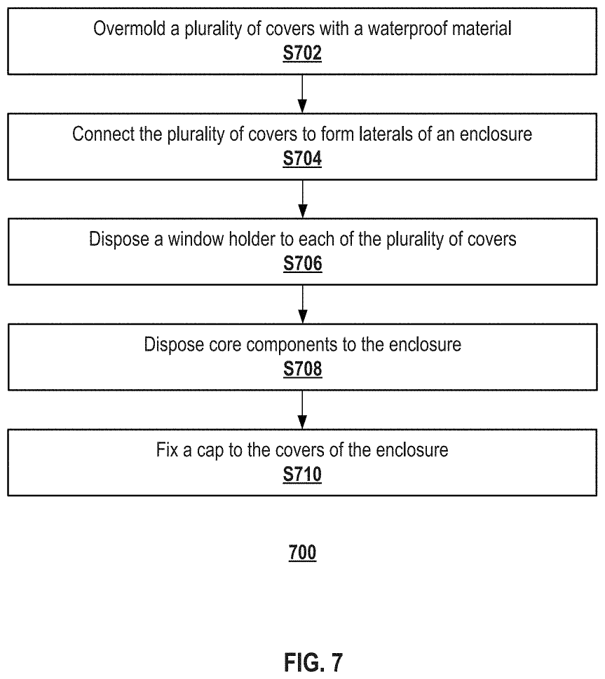

FIG. 7 illustrates a flow chart of an exemplary method 700 for manufacturing LiDAR device 200, according to embodiments of the disclosure. For example, method 700 may be performed by a machine or a streamline of machines preprogramed to manufacture the LiDAR device automatically, or a worker or an artificial intelligence controlling the machine at a LiDAR factory. Method 700 may include steps 702-710 as described below. It is to be appreciated that some of the steps may be optional to perform the disclosure provided herein. Further, some of the steps may be performed simultaneously, or in a different order than shown in FIG. 7.

In step S702, a plurality of covers are overmold with a waterproof material. For example, the waterproof material may cover on each edge of the cover being connected to a connecting/adjacent cover, such that when being connected, the connecting edge of the adjacent covers is water resistant.

In step S704, the plurality of covers are connected to form laterals of an enclosure. For example, each cover may be fixed to two adjacent covers using waterproof screws. The waterproof screws may be cap head screws with the cap head being plated with the waterproof material (e.g., waterproof screw 336 shown in FIG. 4). The connecting covers can be connected using an angle bracket by being fixed to its hands using the waterproof screws. It is contemplated that other suitable waterproof screw-based connecting mechanisms may also be applied.

In step S706, a window holder is disposed on each of the plurality of covers. For example, each window holder may have a plurality of pin holes, each of which is aligned to a pin hole on the cover. The window holder can be fixed to the cover by inserting/screwing at least one waterproof screw into the aligned pin holes. In some embodiments, step S706 may be performed before step S704.

In step S708, core components of the LiDAR device such as the transmitter and the receiver are disposed into the enclosure. For example, the height of the transmitter and the receiver can be substantially the same as the window, holding by each of the window holders, such that the emitted laser beam can be let out to cover the range of scanning angles, and the reflected laser beam can be let in and be received by the receiver through the window. In some embodiments, a motor for generating a relative rotation between the transmitter and the enclosure may also be disposed in the enclosure. In some embodiments, a controller, such as signal processor 220, may also be included inside the enclosure.

In some embodiments, instead of disposing the LiDAR components into an assembled enclosure, the enclosure may be assembled around the LiDAR components. For example, the LiDAR components may be assembled on a substrate, and step S704 is performed to connect the plurality of covers to form laterals around the assembled LiDAR components.

In step S710, a cap may be fixed to the covers of the enclosure to form the LiDAR device. For example, the cap can be fixed to each of the plurality of covers using angular brackets and waterproof screws.

By using waterproof screws (e.g., waterproof screw 336 shown in FIG. 4) to fix parts forming the enclosure of the LiDAR device, embodiments of the present disclosure improve the scalability of the LiDAR device as each part of the enclosure (e.g., the covers and the window holders) is detachable and can be detached conveniently. Moreover, because each part of the enclosure is fixed with waterproof screws without using any glue or welding, the water resistance of the LiDAR device is also improved. Further, by not using glue or welding, the manufacturing of the enclosure can be more environmentally friendly.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor-based, tape-based, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A Light Detection and Ranging (LiDAR) system, comprising:
a transmitter configured to emit a light beam;
a receiver configured to receive the light beam reflected by an object; and
an enclosure enclosing the transmitter and the receiver, the enclosure comprising a plurality of laterals, wherein each of the laterals comprises:
a cover overmold with a first waterproof material; and
a first cap head screw configured to fix the cover to a cover on a connecting lateral.

2. The LiDAR system of claim 1, further comprising:
a window holder disposed on each of the covers, configured to hold a window for letting out and letting in the light beam; and
a second cap head screw configured to fix the window holder to the cover.

3. The LiDAR system of claim 2, wherein an edge of the cover in contact with the connecting cover, is covered with the first waterproof material.

4. The LiDAR system of claim 3, wherein each of the first and second cap head screw comprises a second waterproof material plating a lateral surface of a cap head of the first and second cap head screw.

5. The LiDAR system of claim 4, wherein at least one of the first waterproof material or the second waterproof material is rubber.

6. The LiDAR system of claim 1, wherein each cover is detachable from the enclosure.

7. The LiDAR system of claim 1, wherein the enclosure is in a polygon shape comprising 6 or 8 laterals.

8. The LiDAR system of claim 7, further comprising a motor disposed within the enclosure, configured to generate a relative rotation between the transmitter and the enclosure.

9. A Light Detection and Ranging (LiDAR) system, made by performing a LiDAR manufacturing method, the LiDAR manufacturing method comprising:
fixing a plurality of covers overmold with a first waterproof material to form laterals of an enclosure, using a plurality of first cap head screws, wherein each cover is fixed to two connecting covers of the laterals; and
disposing a transmitter configured to emit a light beam and a receiver configured to receive the light beam reflected by an object in the enclosure.

10. The LiDAR system of claim 9, wherein the LiDAR manufacturing method further comprises:
disposing a window holder on each of the covers, configured to hold a window for letting out and letting in the light beam; and
fixing the window holder to the cover using a second head screw.

11. The LiDAR system of claim 10, wherein the manufacturing method further comprises:
covering an edge of the cover in contact with a connecting cover with the first waterproof material.

12. The LiDAR system of claim 11, wherein the manufacturing method further comprises:
plating a lateral surface of a cap head of each first and second cap head screw with a second waterproof material.

13. The LiDAR system of claim 12, wherein at least one of the first waterproof material or the second waterproof material is rubber.

14. The LiDAR system of claim 9, wherein each cover is detachable from the enclosure.

15. The LiDAR system of claim 9, wherein the enclosure is in a polygon shape comprising 6 or 8 laterals.

16. A Light Detection and Ranging (LiDAR) system, comprising:
a transmitter configured to emit a light beam;
a receiver configured to receive the light beam reflected by an object; and
a plurality of covers forming laterals of a waterproof enclosure, wherein each of the laterals comprises:
a cover overmold with a first waterproofed material; and
a window holder disposed on the cover, configured to hold a window for letting out and letting in the light beam;
wherein connecting covers among the plurality of covers are fixed using a plurality of first waterproof screws.

17. The LiDAR system of claim 16, further comprising:
a plurality of second waterproof screws configured to fix the window holders to the covers.

18. The LiDAR system of claim 17, wherein each edge of each cover is covered with the first waterproof material.

19. The LiDAR system of claim 18, wherein each of the first and the second waterproof screws comprises a second waterproof material plating a lateral surface of a cap head of the first or the second waterproof screw.

20. The LiDAR system of claim 19, wherein at least one of the first waterproof material or the second waterproof material is rubber.
